(19) United States
(12) Patent Application Publication
(10) Pub. No.: US 2013/0258466 A1
(43) Pub. Date: Oct. 3, 2013

(54) STEREOSCOPIC IMAGE DISPLAY DEVICE AND DRIVING METHOD THEREOF

(71) Applicants: Jeong-Keun Ahn, Yongin-city (KR); Back-Woon Lee, Yongin-city (KR); Do-Ik Kim, Yongin-city (KR); Joo-Hyeon Jeong, Yongin-city (KR)

(72) Inventors: Jeong-Keun Ahn, Yongin-city (KR); Back-Woon Lee, Yongin-city (KR); Do-Ik Kim, Yongin-city (KR); Joo-Hyeon Jeong, Yongin-city (KR)

(21) Appl. No.: 13/571,300

(22) Filed: Aug. 9, 2012

(30) Foreign Application Priority Data
Apr. 3, 2012 (KR) 10-2012-0034479

(51) Int. Cl. G02B 27/22

(52) U.S. Cl. 359/466

(57) ABSTRACT

A stereoscopic image display device includes: a scan driver for transmitting scan signals to scan lines; a data driver for transmitting data signals to data lines; a display unit including pixels and configured to receive a corresponding data signal when a corresponding scan signal is transmitted to the pixels; a power supply controller for supplying a driving voltage to drive the pixels; and a controller for controlling the scan driver, the data driver, and the power supply controller, for generating an image data signal corresponding to each period of a plurality of periods, and for supplying the corresponding image data signal to the data driver. The power supply controller controls the driving voltage to block light emitting during a first view point image non-light emitting period and a second view point image non-light emitting period.

### CROSS-REFERENCE TO RELATED APPLICATION

This application claims priority to and the benefit of Korean Patent Application No. 10-2012-0034479, filed in the Korean Intellectual Property Office on Apr. 3, 2012, the entire content of which is incorporated herein by reference.

### BACKGROUND

(a) Field

Embodiments of the present invention relate to a stereoscopic image display device and a driving method thereof. More particularly, embodiments of the present invention relate to a stereoscopic image display device for realizing a stereoscopic image of high image quality and a driving method thereof.

(b) Description of Related Art

Various flat panel displays with reduced weight and volume have been developed, and display devices using various stereoscopic image driving methods to realize 3D stereoscopic images have also been developed.

Examples of the flat panel displays include a liquid crystal display (LCD), a field emission display (FED), a plasma display panel (PDP), an organic light emitting diode (OLED) display, etc.

Among the flat panel displays, the OLED display refers to a flat display device using an electro-luminescence phenomenon of an organic material. The OLED emits light using a mechanism in which electrons and holes are injected from electrodes, and the injected electrons and holes are combined in an excitation state.

The OLED display may have reduced volume and weight because an additional light source is not required, and it may be used for electronic products such as a portable terminal or a large-sized television with low power consumption, high luminous efficiency, high luminance, and wide viewing angle, as well as a fast response speed.

Digital driving, which is one gray expression (e.g., gray level expression) method of the OLED display, adjusts a time when the OLED of the pixel is lit. In the case of the OLED stereoscopic image display that follows the digital driving method, one frame is divided into a plurality of sub-frames and a light emitting period of each sub-frame is appropriately set in order to display a gray. The pixel emits light during a sub-frame among the plurality of sub-frames constituting one frame, selected depending on an image signal for gray expression.

In order to display a stereoscopic image, at least two images corresponding to two different view points should be displayed within one frame display period. In general, a stereoscopic image display device displays a left-eye image and a right-eye image corresponding to both human eyes, a left eye and a right eye, within one frame period.

That is, the period of one frame is divided into a left-eye image display period and a right-eye image display period. The left-eye image display period includes a plurality of sub-frames, and the right-eye image display period includes a plurality of sub-frames.

Furthermore, to reduce or prevent crosstalk of the left-eye image and the right-eye image, a black image display period for displaying a black image in the display panel after the left-eye image display period and the right-eye image display period are respectively completed may be positioned within one frame period.

According to a stereoscopic image driving method, the driving frequency of the OLED display is very high. For example, according to a trend, the size of OLED displays is increasing. If the driving frequency is increased, an incorrect image display operation may occur in the display panel, and driving power consumption of a driver of the display device generated by the high driving frequency may be increased. This may cause an increase in the production cost of the OLED display.

Also, although the display device may be driven according to the method of inserting the black image between the left-eye image display period and the right-eye image display period, crosstalk in which the left-eye image and the right-eye image are mixed by a difference of response speeds in reaction to a shutter opening and closing signal of shutter spectacles may occur. Accordingly, the image quality of the stereoscopic image may be decreased such that a viewer may experience dizziness during viewing.

An improvement in the driving method for realizing a stereoscopic image of high image quality by performing the correct image display operation is needed. There is also a need to simultaneously reduce (e.g., completely prevent) crosstalk by addressing the issue of the increased driving frequency in the OLED display.

The above information disclosed in this Background section is only for enhancement of understanding of the background of the invention and therefore it may contain information that does not form the prior art that is already known in this country to a person of ordinary skill in the art.

### SUMMARY

Aspects of embodiments of the present invention provide a stereoscopic image display device for realizing a 3D stereoscopic image of high image quality that reduces (e.g., prevents) image quality deterioration due to crosstalk, by displaying (e.g., completely displaying) a left-eye image and a right-eye image in the stereoscopic image display device.

Aspects of embodiments of the present invention provide a stereoscopic image display device produced with an economical module production cost by being correctly driven and reducing driving power consumption in a display panel of a large size through stereoscopic image driving of a low driving frequency.

Also, aspects of embodiments of the present invention provide a driving method of a display device that is capable of reducing an RC-delay of the display panel, an erroneous operation of a circuit installed in a TFT, and driving timing of a driver IC and a controller when driving a stereoscopic image of the display device, by reducing the driving frequency.

Aspects of embodiments of the present invention are not limited to the above-described aspects, and other aspects of embodiments of the present invention will be understood by those skilled in the art from the following description.

A stereoscopic image display device according to an exemplary embodiment of the present invention includes: a scan driver for transmitting a plurality of scan signals to a plurality of scan lines; a data driver for transmitting a plurality of data signals to a plurality of data lines; a display unit including a plurality of pixels and for displaying an image, the display unit being configured to receive a corresponding data signal when a corresponding scan signal is respectively transmitted to the plurality of pixels; a power supply controller for supplying a driving voltage to drive the plurality of pixels; and a controller for controlling the scan driver, the data driver, and the power supply controller, for generating an image data signal corresponding to each period of a plurality of periods, wherein the periods are formed by dividing one frame into a first view point image non-light emitting period, a first view point image display period, a second view point image non-light emitting period, and a second view point image display period, and for supplying the corresponding image data signal to the data driver, wherein the power supply controller controls the supply of the driving voltage to block light emitting of the plurality of pixels during the first view point image non-light emitting period and the second view point image non-light emitting period.

The driving voltage may include a first driving voltage applied to one electrode of each organic light emitting element of the plurality of pixels and a second driving voltage applied to another electrode of each organic light emitting element.

The power supply controller may supply a voltage of the second driving voltage during the first view point image non-light emitting period and the second view point image non-light emitting period at a voltage level at which a driving current does not flow to the organic light emitting element to block the light emitting of a plurality of pixels.

The power supply controller may not apply the second driving voltage during the first view point image non-light emitting period and the second view point image non-light emitting period to block the light emitting of the plurality of pixels.

The power supply controller may supply the first driving voltage at a high level, and may supply the second driving voltage at a high level during the first view point image non-light emitting period and the second view point image non-light emitting period and at a low level during the first view point image display period and the second view point image display period.

The power supply controller may supply the first driving voltage at a high level, and may not supply the second driving voltage during the first view point image non-light emitting period and the second view point image non-light emitting period, and may supply the second driving voltage at a low level during the first view point image display period and the second view point image display period.

The first view point image non-light emitting period and the second view point image non-light emitting period may be substantially equal to or longer than a response delay time of a shutter opening and closing of shutter spectacles for transmitting a first view point image and a second view point image of the image of the display unit.

The first view point image non-light emitting period and the first view point image display period may form a left eye frame, the second view point image non-light emitting period and the second view point image display period may form a right eye frame, and the periods of the left eye frame and the right eye frame may be substantially equal to each other.

The data voltage according to the image data signal written in a previous frame may be respectively reset at a start time of the left eye frame and a start time of the right eye frame.

The image data signal supplied in the first view point image non-light emitting period and the first view point image display period may be a left eye image data signal and the image data signal supplied in the second view point image non-light emitting period and the second view point image display period may be a right eye image data signal.

The first view point image non-light emitting period and the first view point image display period may include a plurality of first sub-frames, and the second view point image non-light emitting period and the second view point image display period may include a plurality of second sub-frames.

The plurality of first sub-frames may include a plurality of third sub-frames which form the first view point image non-light emitting period, and a plurality of fourth sub-frames which form the first view point image display period, and the plurality of second sub-frames may include a plurality of fifth sub-frames which form the second view point image non-light emitting period, and a plurality of sixth sub-frames which form the second view point image display period.

The plurality of first sub-frames and the plurality of second sub-frames may be substantially equally arranged, and the plurality of first sub-frames and the plurality of second sub-frames may respectively include a blank sub-frame for adjusting discord of synchronization generated when the first and second sub-frames are arranged in one frame period.

The first view point image non-light emitting period and the first view point image display period may include a plurality of first sub-frames, the scan driver may transmit the scan signal respectively corresponding to the plurality of first sub-frames to the corresponding scan line, and the data driver may supply a plurality of first view point data signals to the plurality of data lines at a time at which the corresponding scan signal is transmitted to the corresponding scan line.

The second view point image non-light emitting period and the second view point image display period may include a plurality of second sub-frames, the scan driver may transmit the scan signal respectively corresponding to the plurality of second sub-frames to the corresponding scan line, and the data driver may supply a plurality of second view point data signals to the plurality of data lines at a time at which the corresponding scan signal is transmitted to the corresponding scan line.

The first view point image non-light emitting period and the first view point image display period may include a plurality of first sub-frames, the second view point image non-light emitting period and the second view point image display period may include a plurality of second sub-frames, and a sequence in which a plurality of corresponding scan signals are respectively transmitted to the plurality of first sub-frames may be substantially the same as a sequence in which a plurality of corresponding scan signals are respectively transmitted to the plurality of second sub-frames.

A scan sequence in which the scan signals respectively corresponding to a plurality of sub-frames forming the first view point image non-light emitting period are transmitted, and a scan sequence in which the scan signals respectively corresponding to a plurality of sub-frames forming the second view point image non-light emitting period are transmitted, may be substantially the same, and a sequence in which the scan signals respectively corresponding to a plurality of sub-frames from a period before respective finishing times of the first view point image display period and the second view point image display period to the respective non-light emitting period, are transmitted, may be substantially the same as the scan sequence.

The scan driver may sequentially transmit the plurality of scan signals in synchronization with a start time of the first view point image non-light emitting period and a start time of the second view point image non-light emitting period, and the controller may generate a first view point image data signal or a second view point image data signal respectively corresponding to the first view point image display period or the second view point image display period, and may compensate the first view point image data signal or the second view point image data signal by an image luminance loss corresponding to the first view point image non-light emitting period or the second view point image non-light emitting period.

According to an exemplary embodiment of the present invention, a method of driving a stereoscopic image display device including a plurality of pixels and configured to display a first view point image and a second view point image during one frame period, includes generating and supplying a first view point image data signal corresponding to a first view point image non-light emitting period and a first view point image display period and a second view point image data signal corresponding to a second view point image non-light emitting period and a second view point image display period; controlling a driving voltage respectively supplied to the plurality of pixels during the first view point image non-light emitting period for blocking light-emitting of the plurality of pixels; emitting light from the plurality of pixels according to the first view point image data signal during the first view point image display period; controlling the driving voltage during the second view point image non-light emitting period to block light-emitting of the plurality of pixels; and emitting light from the plurality of pixels according to the second view point image data signal during the second view point image display period, wherein the first view point image non-light emitting period and the second view point image non-light emitting period are substantially equal to or longer than a response delay time of a shutter opening and closing of shutter spectacles for transmitting the first view point image and the second view point image displayed in the plurality of pixels.

The driving voltage may include a first driving voltage applied to one electrode of each organic light emitting element of the plurality of pixels and a second driving voltage applied to another electrode of each organic light emitting element.

A voltage level of the second driving voltage may be supplied with a voltage level at which a driving current does not flow to the organic light emitting element during the first view point image non-light emitting period and the second view point image non-light emitting period to block the light-emitting of the plurality of pixels.

The second driving voltage may not be applied during the first view point image non-light emitting period and the second view point image non-light emitting period to block the light-emitting of the plurality of pixels.

The first driving voltage may be supplied with a high level, and the second driving voltage may be supplied as a high level during the first view point image non-light emitting period and the second view point image non-light emitting period and as a low level during the first view point image display period and the second view point image display period.

The first driving voltage may be supplied with a high level, and the second driving voltage may not be supplied during the first view point image non-light emitting period and the second view point image non-light emitting period, and may be supplied with a low level during the first view point image display period and the second view point image display period.

The first view point image non-light emitting period and the first view point image display period may form a left eye frame, the second view point image non-light emitting period and the second view point image display period may form a right eye frame, and the periods of the left eye frame and the right eye frame may be substantially equal to each other.

The method may further include resetting a data voltage according to an image data signal written in a previous frame at a start time of the first view point image non-light emitting period and a start time of the second view point image non-light emitting period.

The first view point image non-light emitting period and the first view point image display period may include a plurality of first sub-frames, and the second view point image non-light emitting period and the second view point image display period may include a plurality of second sub-frames.

The plurality of first sub-frames and the plurality of second sub-frames may be substantially equally arranged, and the plurality of first sub-frames and the plurality of second sub-frames may further include a blank sub-frame for controlling disaccord of synchronization generated when the first and second sub-frames are arranged in one frame period.

The plurality of first sub-frames included in the first view point image non-light emitting period and the second view point non-light emitting period may be repeated during a period corresponding to the first view point image non-light emitting period and the second view point non-light emitting period from a time before respective finishing times of the plurality of first sub-frames and the plurality of second sub-frames.

The generating and supplying of the first view point image data signal and the second view point image data signal may include compensating an image luminance loss corresponding to the first view point image non-light emitting period or the second view point image non-light emitting period.

According to aspects of embodiments of the present invention, crosstalk that causes image quality deterioration due to mixture of the left-eye image and the right-eye image for realizing a 3-D stereoscopic image may be addressed such that a 3-D stereoscopic image of high image quality may be displayed.

According to aspects of embodiments of the present invention, in the stereoscopic image display device displaying the stereoscopic image, the driving frequency is decreased (e.g., largely decreased) such that the power consumption of the module circuit may be decreased and the module production cost may be reduced.

Also, according to aspects of embodiments of the present invention, a method for driving the stereoscopic image through low driving frequency is provided such that the driving timing is sufficient, and the RC-delay of the display panel, the erroneous operation of the TFT installation circuit, and the driving timing of the driver IC and the controller may be addressed.

### BRIEF DESCRIPTION OF THE DRAWINGS

FIG. 1 is a block diagram of a stereoscopic image display device according to an exemplary embodiment of the present invention.

FIG. 2 is a circuit diagram of a circuit configuration of a pixel of the stereoscopic image display device of FIG. 1.

FIG. 3 is a driving waveform of a driving method of a conventional stereoscopic image.

FIG. 4 is a driving waveform of a driving method of a stereoscopic image and a response waveform of shutter spectacles according to an exemplary embodiment of the present invention.

FIG. 5 is a schematic diagram of a plurality of sub-frames dividing one frame period according to an exemplary embodiment of the present invention.

FIG. 6 is a driving waveform of a driving method of a stereoscopic image according to an exemplary embodiment of the present invention.

FIG. 7 is an enlarged view of a portion of the driving waveform diagram of FIG. 6 and driving timing of a scan signal according thereto.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Constituent elements having the same structures throughout the embodiments are denoted by the same reference numerals and are described in a first embodiment. In the other embodiments, only constituent elements different from those of the first embodiment will be described.

In addition, parts not related to the description are omitted for clear description of the present invention, and like reference numerals designate like elements and similar constituent elements throughout the specification.

Throughout this specification and the claims that follow, when it is described that an element is “coupled” to another element, the element may be “directly coupled” to the other element or “electrically coupled” to the other element through a third element therebetween. In addition, unless explicitly described to the contrary, the word “comprise” and variations such as “comprises” or “comprising” will be understood to imply the inclusion of stated elements but not the exclusion of any other elements.

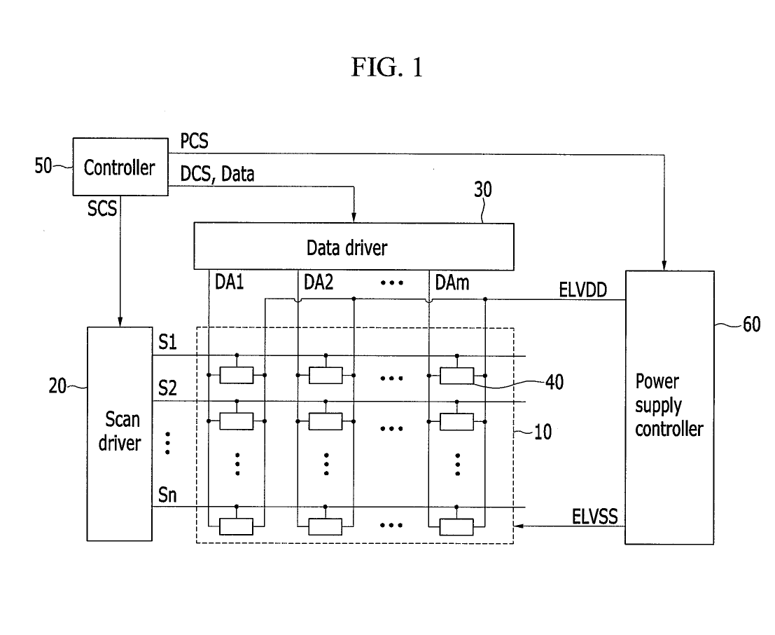

FIG. 1 is a block diagram of a stereoscopic image display device according to an exemplary embodiment of the present invention.

Referring to FIG. 1, a stereoscopic image display device according to an exemplary embodiment of the present invention includes a display unit 10 including a plurality of pixels 40 respectively coupled to scan lines S1 to Sn and data lines DA1 to DAm, a scan driver 20 for driving the scan lines S1 to Sn by supplying a scan signal to the scan lines, a data driver 30 for driving the data lines DA1 to DAm by supplying a data signal to the data lines, a power supply controller 60 coupled to the display unit 10 and for supplying power, and a controller 50 for controlling the scan driver 20, the data driver 30, and the power supply controller 60.

The controller 50 generates a data driving control signal DCS, a scan driving control signal SCS, and a power supply control signal PCS corresponding to synchronization signals supplied from an external source. The data driving control signal DCS is supplied to the data driver 30 and the scan driving control signal SCS is supplied to the scan driver 20. Also, the power supply control signal PCS is transmitted to the power supply controller 60.

In addition, the controller 50 converts an image signal supplied from an external source into an image data signal Data and supplies the image data signal Data to the data driver 30.

The image data signal Data includes a first view point image data signal and a second view point image data signal.

In one embodiment, the first view point image data signal may be a left eye image data signal and the second view point image data signal may be a right eye image data signal, however the reverse thereof is possible.

For convenience, it is assumed that the first viewpoint is for the left eye and the second viewpoint is for the right eye.

The OLED display according to an exemplary embodiment of the present invention may display the stereoscopic image by using a binocular disparity. Accordingly, to display the stereoscopic image, the left-eye image and the right-eye image respectively corresponding to two viewpoints are sequentially displayed. Also, the left-eye image and the right-eye image are transmitted to two eyes of the user with a disparity (e.g., a predetermined disparity), and additional liquid crystal shutter spectacles (not shown) are required to recognize the stereoscopic image.

For example, the user should wear spectacles which allow an image to be transmitted to only the left eye during a period of displaying the left eye image and transmitted to only the right eye during a period of displaying the right eye image.

The data driver 30 supplies a plurality of image data signals to a plurality of data lines DA1 to Dam for a plurality of sub-frame periods included in one frame. In one embodiment, the data driver 30 generates the data voltages corresponding to a plurality of left eye image data signals and a plurality of right eye image data signals according to a data driving control signal DCS from the controller, and transmits them to a plurality of data lines.

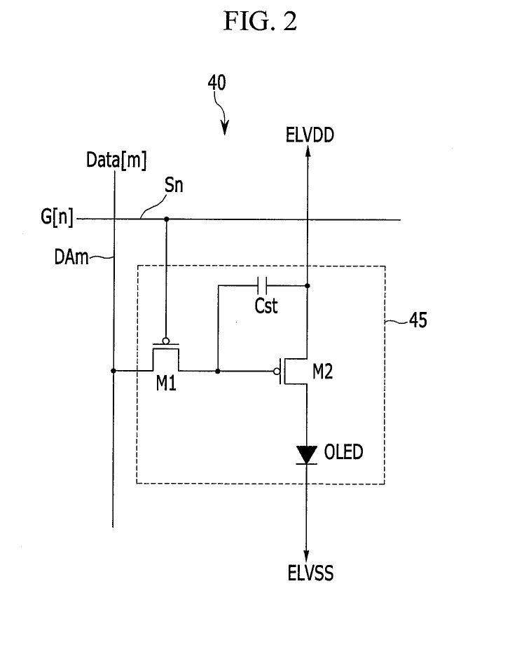

In a stereoscopic image display device according to an exemplary embodiment of the present invention, which includes a plurality of sub-frames for one frame, the data driver 30 transmits the left eye or the right eye image data signals including the left eye or the right-eye images to a plurality of pixels 40 in synchronization with a view point at which the scan signal having the gate on voltage corresponding to each sub-frame is supplied. The gate-on voltage means a voltage level for turning on the switching transistor such that the data signal is transmitted to the gate electrode of the driving transistor transmitting the driving current to the OLED. This is described in detail with reference to the pixel structure of FIG. 2.

In one embodiment, during one frame in which the image is displayed in the stereoscopic image display device, a plurality of left eye data signals are transmitted during each sub-frame of the left-eye image display period and a plurality of right eye data signals are transmitted during each sub-frame of the right-eye image display period through a plurality of data lines.

The scan driver 20 supplies a scan signal having the gate-on voltage to a corresponding scan line among a plurality of scan lines (S1 to Sn) in synchronization with a starting point of each sub-frame. A plurality of pixels 40 coupled to the scan line supplied with the scan signal having the gate-on voltage among a plurality of scan lines S1 to Sn are selected. The plurality of pixels 40 selected by the scan signal are supplied with the left eye image data signal or the right eye image data signal from the plurality of data lines DA1 to DAm according to the corresponding sub-frame. In one embodiment, the corresponding sub-frame means the sub-frame corresponding to the scan signal having the gate-on voltage.

The power supply controller 60 controls a voltage supply of the first power ELVDD and the second power ELVSS supplying the driving voltage to the display unit 10. The power supply controller 60 supplies the driving voltage to the display unit 10 according to the power supply control signal PCS transmitted from the controller 50.

The first power ELVDD and the second power ELVSS supply two driving voltages for the operation of a plurality of pixels 40. The two driving voltages include the first driving voltage supplied from the first power ELVDD and the second driving voltage supplied from the second power ELVSS, and the power supply control signal PCS controls their voltage levels. For example, the first driving voltage supplied from the first power ELVDD during one frame is supplied at a high level (e.g., a predetermined high level), and the second driving voltage applied to a cathode of the OLED of each pixel of the display unit 10 through the second power ELVSS is transmitted at a high level (e.g., a predetermined high level) and a low level (e.g., a predetermined low level). The power supply control signal PCS controls the voltage level of the second driving voltage during one frame.

Next, referring to a circuit diagram shown in FIG. 2, the circuit structure (or constitution) of the pixel 40 of the stereoscopic image display device shown in FIG. 1 will be described.

FIG. 2 shows a pixel circuit 45 of a pixel 40 coupled to a corresponding scan line Sn and a corresponding data line DAm, and the power supply coupled to the first power ELVDD and the second power ELVSS, among a plurality of pixels forming the display unit 10 of FIG. 1.

Referring to FIG. 2, the pixel circuit 45 includes a switching transistor M1, a driving transistor M2, a storage capacitor Cst, and an OLED. FIG. 2 is one exemplary embodiment of the driving circuit of the pixel, however this structure is not limited, and the structure of the pixel circuit for emitting light from the OLED to display images as disclosed in the art may be variously applied.

The pixel circuit 45 according to the exemplary embodiment of FIG. 2 includes a switching transistor M1 having a gate electrode coupled to the corresponding scan line among the plurality of scan lines, a source electrode coupled to the corresponding data line among the plurality of data lines, and a drain electrode coupled to a node coupled to one terminal of the storage capacitor Cst and the gate electrode of the driving transistor M2.

Also, the pixel circuit 45 includes the driving transistor M2 having the gate electrode coupled to the drain electrode of the switching transistor M1, the source electrode coupled to the first power ELVDD, and the drain electrode coupled to an anode of the OLED.

The storage capacitor includes one terminal coupled to the node coupled to the drain electrode of the switching transistor M1 and the gate electrode of the driving transistor M2 and the other terminal coupled to the source electrode of the driving transistor M2, thereby maintaining a voltage difference between the gate electrode and the source electrode of the driving transistor M2 during the sub-frame period.

The anode of the OLED is coupled to the drain electrode of the driving transistor M2, and the cathode thereof is coupled to the second power ELVSS.

In a driving method of the stereoscopic image display device according to an embodiment of the present invention, the OLED controls the light emission with the driving current according to the image data signal and according to the control of the driving voltage level supplied from the first power ELVDD coupled through the driving transistor M2 and the second power ELVSS coupled to the cathode.

In one embodiment, when the first driving voltage at a high level (e.g., a predetermined high level) is applied from the first power ELVDD and the second driving voltage at a low level (e.g., a predetermined low level) is applied from the second power ELVSS, the OLED emits the light with the driving current corresponding to the image data signal to display the image. In contrast, when the second driving voltage at a high level (e.g., a predetermined high level) is applied from the second power ELVSS coupled to the cathode, the OLED can control the flow of the driving current such that the light is not emitted, thereby not displaying the images. In a driving method according to an embodiment of the present invention, the image display of the display unit may be controlled by controlling the supply level of the first power ELVDD and the second power ELVSS during a period (e.g., a predetermined period) of each sub-frame included in one frame.

Referring to the operation of the pixel circuit 45, in one embodiment, when the switching transistor M1 is turned on by the scan signal G[n] transmitted through the corresponding scan line Sn, the image data signal Data[m] transmitted through the turned on switching transistor M1 is transmitted to the gate electrode of the driving transistor M2. The voltage difference between the gate electrode and the source electrode of the driving transistor M2 is a first driving voltage difference between the image data signal and the first power supply ELVDD, and a driving current flows in the driving transistor M2 in accordance with (or depending on) the corresponding voltage difference.

The driving current is transferred to the OLED and the OLED emits light in accordance with (or depending on) the transferred driving current.

When the plurality of scan signals having the gate-on voltage level are supplied to a corresponding scan line among the plurality of scan lines S1 to Sn, the plurality of switching transistors M1 coupled to the corresponding scan line are turned on. A plurality of data lines DA1 to Dam transmit the left eye data signal or the right eye data signal in synchronization with the view point at which the scan signal having the gate-on voltage is supplied.

The left eye data signal or the right eye data signal transmitted to a plurality of data lines DA1 to DAm through each of a plurality of turned on switching transistors M1 is transmitted to each driving transistor M2 of a plurality of pixels 40, and each OLED of a plurality of pixels 40 performs the light emitting or the non-light emitting with the driving current corresponding to the transmitted data signal during a corresponding sub-frame period. As described above, the light emitting or the non-light emitting of the OLED may be controlled with the driving voltage level supplied from the first power ELVDD and the second power ELVSS. For example, if the voltage level of the first driving voltage supplied from the first power ELVDD is fixed at a high level (e.g., a predetermined high level), the light emission control of the pixel circuit 45 depends on the voltage level of the second driving voltage supplied from the second power ELVSS.

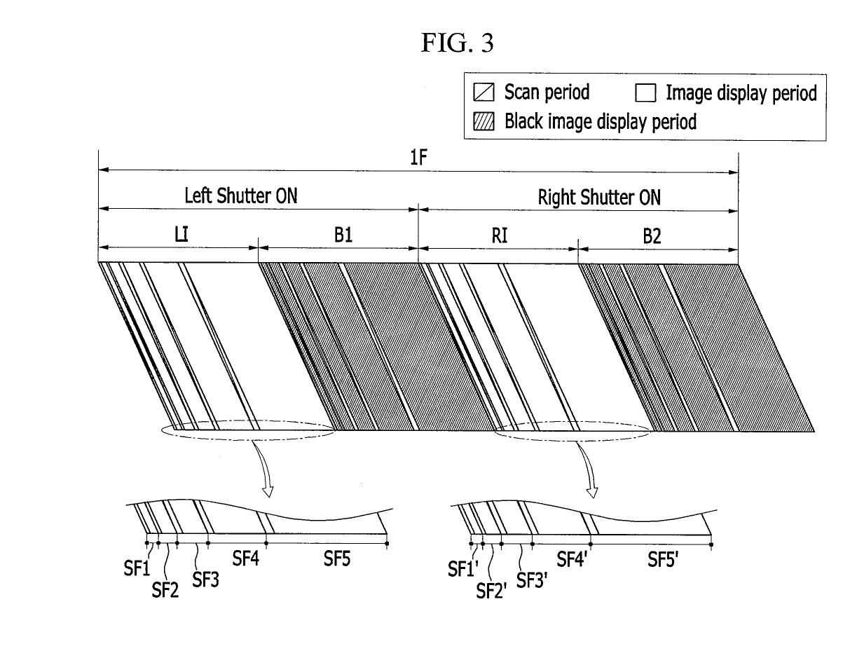

FIG. 3 is a driving waveform diagram of a conventional driving method of a stereoscopic image.

In one embodiment, the left-eye image and the right-eye image are alternately displayed to display the 3D stereoscopic image, and one frame 1F includes black image display periods B1 and B2 after the left-eye image display period LI and the right-eye image display period RI. In FIG. 3, the left-eye image display period LI, the right-eye image display period RI, and the black image display periods B1 and B2 are equal to each other, and the number of sub-frames included in each period and the arrangement of the plurality of sub-frames are equal to each other.

As shown in FIG. 3, the left eye shutter of the spectacles is only turned on during the left-eye image display period LI and the black image display period B1 such that the image is projected only to the left eye. Also, the right eye shutter of the spectacles is only turned on during the right-eye image display period RI and the black image display period B2 such that the image is projected only to the right eye.

The left-eye image display period LI among the period in which the left shutter is in the on state has the arrangement of a plurality of sub-frames SF1 to SF5, and the plurality of scan signals having the gate on voltage are sequentially transmitted to the plurality of scan lines in synchronization with the starting point of each sub-frame. In one embodiment, when the plurality of scan signals are transmitted, the plurality of left eye data signals are transmitted to the plurality of pixels through the plurality of data lines. Thus, each OLED of the plurality of pixels emits an image during the corresponding sub-frame according to the left eye data signal, thereby displaying the left-eye image.

The right-eye image display period RI among the period in which the right shutter is in the on state has the arrangement of a plurality of sub-frames SF1′ to SF5′. Also, the plurality of scan signals having the gate on voltage are sequentially transmitted to the plurality of scan lines in synchronization with the starting point of each sub-frame, and the plurality of right eye data signals transmitted through the plurality of data lines are transmitted to the plurality of pixels. Thus, each OLED of the plurality of pixels emits light during the corresponding sub-frame according to the right eye data signal, thereby displaying the right-eye image.

In one embodiment, the black image display periods B1 and B2 as periods for preventing the mixture of the right and left images may be inserted between the left-eye image display period LI and the right-eye image display period RI.

The black image display period B1 after the left-eye image display period LI has the same sub-frames SF1-SF5 as the sub-frames of the left-eye image display period LI. The plurality of scan signals having the gate-on voltage are sequentially transmitted to the plurality of scan lines in synchronization with the starting point of each sub-frame, however, at this time, a plurality of black data signals are transmitted to the plurality of pixels through the plurality of data lines during the corresponding sub-frame such that each OLED of the plurality of pixels does not emit light.

The black image display period B2 after the right-eye image display period RI has the same sub-frames SF1′-SF5′ as the sub-frames of the right-eye image display period RI. The plurality of scan signals having the gate-on voltage are sequentially transmitted to the plurality of scan lines in synchronization with the starting point of each sub-frame, however, at this time, a plurality of black data signals are transmitted to the plurality of pixels through the plurality of data lines during the corresponding sub-frame such that each OLED of the plurality of pixels does not emit light.

The black image display period B1, in which the black data signal is supplied such that the light emitting is not executed, may be inserted in the left-eye image display period LI in which the left eye data signal is supplied such that the light emitting is executed during the corresponding sub-frame period. The black image display period B2, in which the black data signal is supplied such that the light emitting is not executed, may be inserted in the right-eye image display period RI in which the right eye data signal is supplied such that the light emitting is executed during the corresponding sub-frame period.

According to one embodiment, when 1 frame cycle is determined to be 1/60 sec, to transmit the plurality of data signals to the display unit during the left-eye image display period LI, the black image display period B1, the right-eye image display period RI, and the black image display period B2, the driving frequency of the OLED display in 1 frame cycle is determined to be 240 Hz. Accordingly, this digital driving has a frequency that is increased by four times compared with the 2D display driving.

If the driving frequency is increased to a high frequency, it may be difficult to correctly drive a display panel of a large size because of RC delay of the data/scan lines, and the driving power consumption may be increased. Also, it may be difficult to obtain a period to compensate the threshold voltage in the pixel circuit under the high frequency driving. The integrated circuit of the data driver and the scan driver may be designed to correspond to the high speed driving such that the module cost of the whole display device is increased.

Also, although the black image display period is inserted to separate the left-eye image and the right-eye image, the left eye shutter and the right eye shutter may be simultaneously turned on due to the response speed delay according to an opening and closing signal of the shutter spectacles such that the left-eye image and the right-eye image may still be mixed.

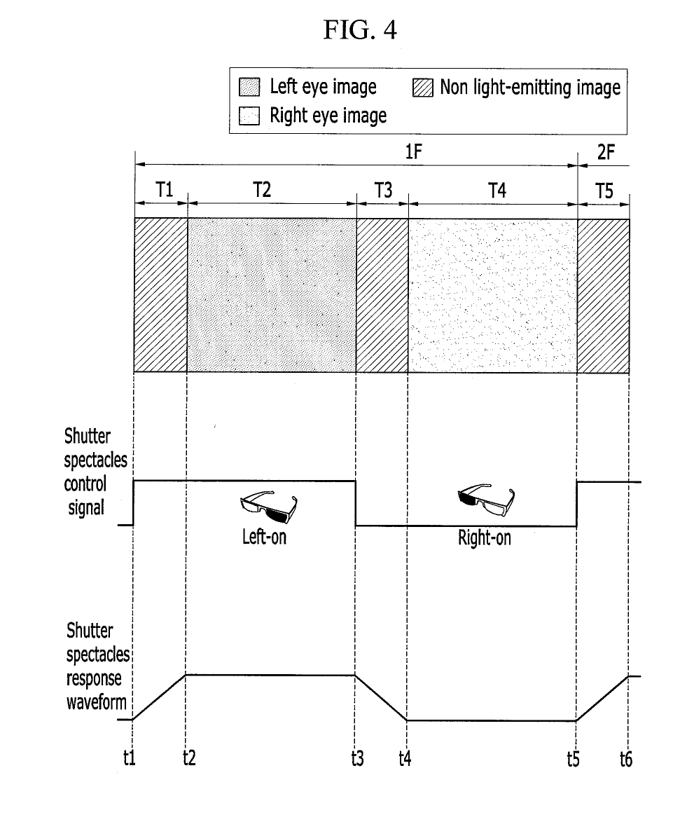

FIG. 4 is a waveform diagram of the driving method of the stereoscopic image in the stereoscopic image display device according to an exemplary embodiment of the present invention to address the issue of the conventional art as in FIG. 3.

Referring to FIG. 4, in one embodiment one frame period 1F to realize the stereoscopic image includes a left-eye image non-light emitting period T1, a left-eye image display period T2, a right-eye image non-light emitting period T3, and a right-eye image display period T4. If the right-eye image display period T4 is finished, the period of the next frame is started, and the left-eye image non-light emitting period T5 corresponding to the next frame period is repeated. The left-eye image non-light emitting period T1 and the left-eye image display period T2, and the right-eye image non-light emitting period T3 and the right-eye image display period T4, may be repeated in a sequence (e.g., with an exchanged sequence).

In one embodiment, a plurality of scan signals are transmitted and a plurality of left eye data signals are transmitted to a plurality of pixels in synchronization with the starting point of each sub-frame of the left-eye image non-light emitting period T1 and the left-eye image display period T2. Thus, the left eye shutter of the shutter spectacles is turned on and opened to recognize the left-eye image displayed according to a plurality of left eye data signals to the left eye.

Likewise, a plurality of scan signals are transmitted and a plurality of right eye data signals are transmitted to a plurality of pixels in synchronization with the starting point of each sub-frame of the right-eye image non-light emitting period T3 and the right-eye image display period T4. Thus, the right eye shutter of the shutter spectacles is turned on and opened to recognize the right-eye image displayed according to a plurality of right eye data signals to the right eye.

However, according to an exemplary embodiment of the present invention, during the left-eye image non-light emitting period T1 and the right-eye image non-light emitting period T3, the OLED of the pixels receiving the left eye or right eye image data signals is not driven, such that the entire display unit including these pixels does not emit the light. Accordingly, the left-eye image and the right-eye image may be separated (e.g., completely separated) rather than as in the conventional art of FIG. 3 when inserting the black image by transmitting the black image data signal between the left-eye image display period and the right-eye image display period. For example, the left-eye image display period and the right-eye image display period may be separated through the driving method including the black image display periods B1 and B2 of FIG. 3. However, like the response waveform of the shutter spectacles according to the shutter spectacles control signal shown in FIG. 4, the left-eye image and the right-eye image may be mixed and transmitted through the shutter spectacles that are opened during the response delay times t1 to t2, t3 to t4, and t5 to t6 due to the response delay caused by the liquid crystal reaction speed at the converting viewpoints t1, t3, and t5 of the right and left shutter spectacles.

For example, as shown in the shutter spectacles response waveform of FIG. 4, when the left eye shutter and the right eye shutter are alternately opened according to the shutter spectacles control signal, a period in which two shutters are opened may be generated, and at this time, crosstalk may be generated if the light is emitted according to the image data signal. According to a conventional art, the crosstalk may be still generated such that the image quality of the stereoscopic image may be deteriorated.

However, in an exemplary embodiment of the present invention, the organic light emitting element of the pixels of the display unit is turned off during the response delay times t1 to t2, t3 to t4, and t5 to t6 such that the corresponding image is not completely displayed, and thereby the left-eye image display period T2 and the right-eye image display period T4 may be separated (e.g., completely separated) such that the crosstalk may be reduced (or prevented).

Referring to FIG. 4, in the organic light emitting stereoscopic image display device according to an exemplary embodiment of the present invention, the non-light emitting periods T1, T3, and T5 may be shorter than the left-eye image display period T2 and the right-eye image display period T4.

If, as described above, one frame period is determined as 1/60 sec (16.7 ms), in one embodiment the left-eye image transmitted to the left eye shutter spectacles and the right-eye image transmitted to right eye shutter spectacles are respectively transmitted during half a frame. However, to prevent the mixture of the left eye image and the right-eye image, the non-light emitting period is determined to be at least longer than the response delay time of the shutter spectacles such that the left-eye image display period and the right-eye image display period are long enough compared with the conventional art, thereby decreasing the driving frequency. Accordingly, the stereoscopic image display device according to an embodiment of the present invention may be driven with sufficient driving timing such that the issues of a RC-delay of the display panel, an erroneous operation of a TFT installing circuit, and driving timing of the driver IC and the controller may be solved. Also, a low luminance and obtaining a threshold voltage compensation period generated by a reduction of the display period when displaying the stereoscopic image may be addressed.

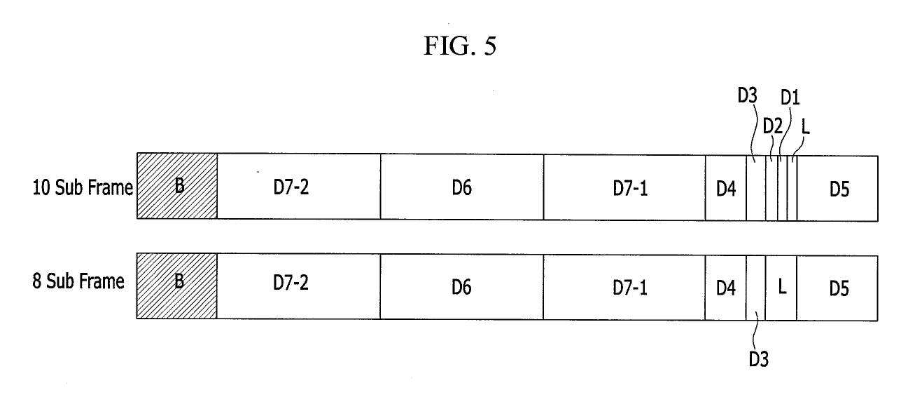

FIG. 5 is a schematic diagram of a plurality of sub-frames dividing one frame period according to an exemplary embodiment of the present invention.

One frame period according to an exemplary embodiment of the present invention of FIG. 5 includes a plurality of sub-frames.

An exemplary embodiment includes eight sub-frames including a blank sub-frame B, and another exemplary embodiment may include ten sub-frames including a blank sub-frame B. A plurality of sub-frames of FIG. 5 may be a plurality of left eye sub-frames corresponding to the left-eye image display period, however they may be a plurality of right eye sub-frames corresponding to the right-eye image display period.

The blank sub-frame B is a period (e.g., a predetermined period) to address the discord of the synchronization generated even when a plurality of left eye frames and a plurality of right eye frames are appropriately arranged in the corresponding display period. In one embodiment, the difference between the left-eye image display period T2 or the right-eye image display period T4 and the period of a plurality of left eye sub-frames or a plurality of right eye sub-frames of FIG. 4 may be determined as the blank sub-frame. For example, if the sum period of the left eye frames of D7-1, D7-2, D6, D5, D4, D3, D2, D1, and L is less than the left-eye image display period T2, the period difference therebetween is assigned as the blank sub-frame B. The right-eye image display period is the same.

As shown in FIG. 5, a left eye or right eye frame of a plurality of left eye or right eye frames may include ten sub-frames B, L, D1, D2, D3, D4, D5, D6, D7-1, and D7-2 or eight sub-frames B, L, D3, D4, D5, D6, D7-1, and D7-2.

When the left eye or right eye frames of the plurality of left eye or right eye frames include ten sub-frames, the longest sub-frame is the period D7, and in an exemplary embodiment of the present invention, the longest sub-frame period may be divided into the first period D7-1 and the second period D7-2, and at least one sub-frame may be disposed between two divided sub-frames (i.e., between the first period D7-1 and the second period D7-2).

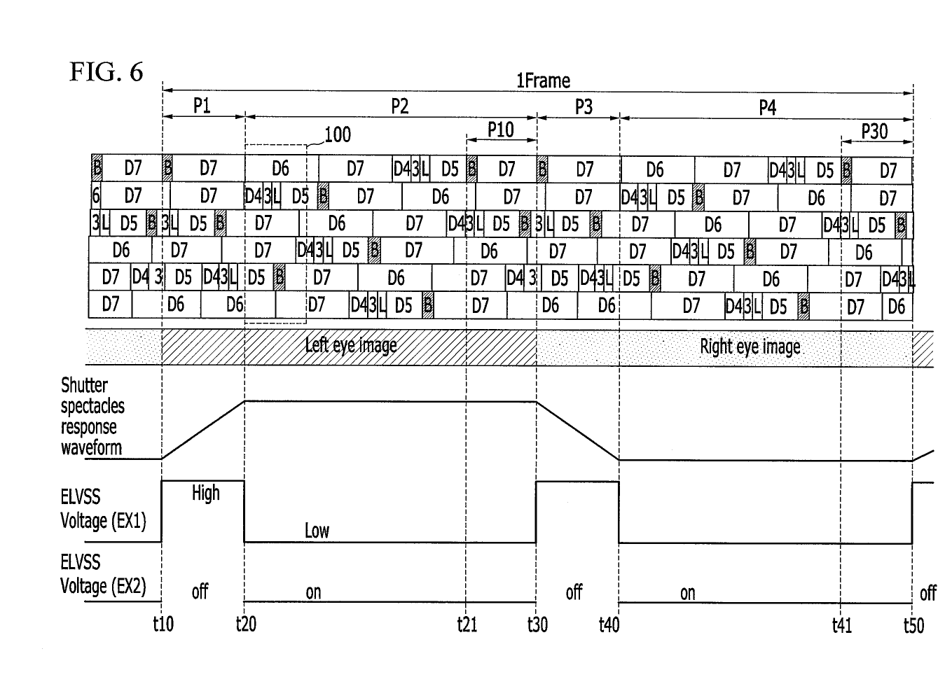

FIG. 6 is a driving waveform diagram of a driving method of a stereoscopic image according to an exemplary embodiment of the present invention.

For better understanding and ease of description, it is shown that the display unit only includes a pixel row corresponding to six scan lines. In FIG. 6, a plurality of blocks corresponding to six scan lines in the up and down directions are arranged with a plurality of sub-frames according to the time sequence for the image displayed in each pixel row coupled to each scan line.

Referring to FIG. 6, in the digital driving according to an exemplary embodiment of the present invention, as the driving waveform of the driving method with reduced frequency, the period of 1 frame is 1/60 sec, and includes four periods P1 to P4.

In one embodiment, a left eye or right eye data signal (e.g., a predetermined left eye or right eye data signal) is supplied to the pixels activated in accordance with the scan signal transmitted through the corresponding scan line. However, each OLED of the pixels is not driven, such that the first period P1 and the third period P3 are the non-light emitting periods in which light is not emitted. That is, according to the exemplary embodiment of FIG. 6, the first period P1 may be referred to as the left-eye image non-light emitting period, and the third period P3 may be referred to as the right-eye image non-light emitting period.

However, the second period P2 and the fourth period P4 are the light emitting periods in which the left eye or right eye data signal (e.g., the predetermined left eye or right eye data signal) is supplied to the pixels activated according to the scan signal transmitted through the corresponding scan line to be displayed. That is, the second period P2 and the fourth period P4 are the periods in which each OLED of the pixels is driven such that the driving current corresponding to the left eye or right eye data signal flows, thereby displaying the corresponding image. According to the exemplary embodiment of FIG. 6, the second period P2 may be referred to as the left-eye image display period, and the fourth period P4 may be referred to as the right-eye image display period.

The sum period of the first period P1 and the second period P2 is the left-eye image period in which the left eye image data signal is transmitted, and the sum period of the third period P3 and the fourth period P4 is the right-eye image period in which the right eye image data signal is transmitted. The left-eye image period and the right-eye image period form one frame.

In one embodiment, a storing data voltage of all pixels included in the display unit is reset in synchronization with the view point t10 at which the left-eye image period is started and the view point t30 at which the right-eye image period is started. For the stereoscopic image display device, the left-eye image and the right-eye image are displayed during one frame such that all pixels of the display unit experience two reset processes.

The voltage level of the shutter spectacles opening and closing signal is inverted and transmitted in synchronization with the view point t10 at which the left-eye image period is started and the view point t30 at which the right-eye image period is started. However, when the opening and closing of the left eye and right eye shutters of the shutter spectacles are crossed according to the shutter spectacles opening and closing signal, the response is delayed by the reaction speed like the shutter spectacles response waveform of FIG. 6. Accordingly, the opening and closing of the left eye shutter and the right eye shutter are performed (e.g., completely performed) at the view point t20 and the view point t40 after the period (e.g., the predetermined period).

According to an exemplary embodiment of the present invention, the left-eye image non-light emitting period P1 and the right-eye image non-light emitting period P3 may be set up during the periods t10 to t20, and t30 to t40, in which the response of the shutter spectacles is delayed.

Thus, although the left eye data signal or the right eye data signal is transmitted during a plurality of corresponding left eye sub-frames or a plurality of corresponding right eye sub-frames, the OLED of each pixel of the display unit is not driven and does not emit light, such that the image is not displayed although the binocular shutter may be opened by the response delay of the shutter spectacles.

The light emission blocking of the left-eye image non-light emitting period P1 and the right-eye image non-light emitting period P3 may be performed by controlling the voltage level of the second driving voltage of the second power ELVSS applied through the power supply line coupled to each pixel of the display unit as shown in FIG. 6.

For example, according to a first exemplary embodiment (ELVSS voltage (EX1)), the voltage level of the second driving voltage of the second power ELVSS is supplied at a high level during the periods t10 to t20, and t30 to t40, in which the response of the shutter spectacles is delayed. The voltage level of the second driving voltage of the second power ELVSS is supplied at a low level during the rest of the image display periods t20 to t30, and t40 to t50. The voltage level of the second driving voltage according to the first exemplary embodiment corresponds to a case in which the transistor of the pixel circuit 45 shown in FIG. 2 is a PMOS transistor. However, the voltage level of the second driving voltage may be variously controlled when the transistor type of the pixel circuit is different.

In an embodiment of the display unit including the pixel circuit shown in FIG. 2, the voltage level of the second driving voltage of the second power ELVSS is a high level during the shutter spectacles response delay periods t10 to t20, and t30 to t40. The voltage applied to the cathode of the OLED is increased such that the driving current does not flow through the OLED, thereby the light emitting is blocked.

Also, according to a second exemplary embodiment (ELVSS voltage (EX2)), the voltage level of the second driving voltage of the second power ELVSS is not switched (e.g., swung) during the delay periods t10 to t20, and t30 to t40, of the shutter spectacles and the second power ELVSS is turned off to block the light emitting. The second power ELVSS is turned on during the rest of the image display periods t20 to t30, and t40 to t50, such that the image is displayed. According to the second exemplary embodiment, the power consumption to drive the image display device is decreased compared with the first exemplary embodiment.

Meanwhile, the loss of the sub-frame image corresponding to the non-light emitting period P1 and P3 is generated in the left eye frame and the right eye frame due to the light emission blocking of the left-eye image non-light emitting period P1 and the right-eye image non-light emitting period P3, such that the image during the loss of the sub-frame is displayed in the left-eye image display period P2 and the right-eye image display period P4.

For example, although the second driving voltage of the second power ELVSS is applied at a high level during the left-eye image non-light emitting period P1 and the right-eye image non-light emitting period P3, the scan driver is operated such that the scanning and the data writing are performed. Accordingly, after the left eye or right eye image data signal is written in the left-eye image display period P2 and the right-eye image display period P4, the image data signal of the lost sub-frame period for the light emitting is written in a fifth period P10 (e.g., a predetermined fifth period P10) and a sixth period P30 (e.g., a predetermined sixth period P30) for compensating the luminance loss. Accordingly, the fifth period P10 and the sixth period P30 may include a plurality of sub-frames like the first period P1 and the third period P3 of the non-light emitting period.

Meanwhile, a detailed driving process of the stereoscopic image display device according to an embodiment of the present invention is described below. The corresponding scan signals are generated in synchronization with the starting point of the plurality of sub-frames consisting of the first period P1 and the third period P3, and the corresponding pixels among the plurality of pixels included in the display unit are scanned according to the corresponding scan signal. Here, the sequence in which the plurality of scan signals corresponding to the plurality of sub-frames are generated during the first period P1 is the same as the sequence in which the plurality of scan signals corresponding to the plurality of sub-frames are generated during the third period P3.

Likewise, the corresponding scan signals are generated in synchronization with the starting point of the plurality of sub-frames included in the second period P2 and the fourth period P4. The corresponding pixels among the plurality of pixels included in the display unit are scanned according to the corresponding scan signal, and thereby the left eye or the right eye data signal is transmitted such that the image is displayed. Here, the sequence in which the plurality of scan signals corresponding to the plurality of sub-frames are generated during the second period P2 is the same as that of the fourth period P4.

In one embodiment the controller of the display device resets the counters at the viewpoint at which the second period P2 and the fourth period P4 of the image display period are finished such that the initial viewpoint of the digital driving is returned, thereby starting the next left eye or right eye sub-frame.

In FIG. 6, if the left-eye image non-light emitting period P1, the left-eye image display period P2, the right-eye image non-light emitting period P3, and the right-eye image display period P4 are operated, the digital driving is again repeated from the left-eye image non-light emitting period P1 in the new frame.

In the exemplary embodiment of FIG. 6, the number of sub-frames arranged corresponding to a plurality of scan lines is 10, however it is not limited thereto, and 8 sub-frames as shown in FIG. 5 may be employed.

Referring to FIG. 6, the first scan line is arranged with the sequence of the sub-frames D6, D7, D4, D3, L, D5, blank (B), and D7 for the second period P2 of the left-eye image display period or the fourth period P4 of the right-eye image display period. In FIG. 6, the sub-frame D3 having the relatively short period is represented by “3”.

Among a plurality of sub-frames, the blank sub-frame B and the sub-frame D7 corresponding to the period P10 or the period P30 are the same as the sub-frame included in the left-eye image non-light emitting period P1 or the right-eye image non-light emitting period P3. For example, in the sub-frame included in the left-eye image non-light emitting period P1 or the right-eye image non-light emitting period P3, the light is not emitted with the driving current according to the data signal. The same sub-frame is written after the writing of the image data signal of the second period P2 or the fourth period P4 to compensate the luminance loss of the left-eye image and the right-eye image, thereby realizing the image. This constituent shape of the sub-frame is equally applied after the first scan line.

In one embodiment, the left-eye image non-light emitting period P1 or the right-eye image non-light emitting period P3 is equal to or greater than the period corresponding to the response delay time of the shutter spectacles. The driving of all pixels of the display unit is off during a time when the left and right eye shutters of the shutter spectacles are crossed such that the crosstalk may be reduced (e.g., completely prevented), and simultaneously the display period of the left-eye image or the right-eye image may be sufficiently obtained, thereby sufficiently decreasing the driving frequency.

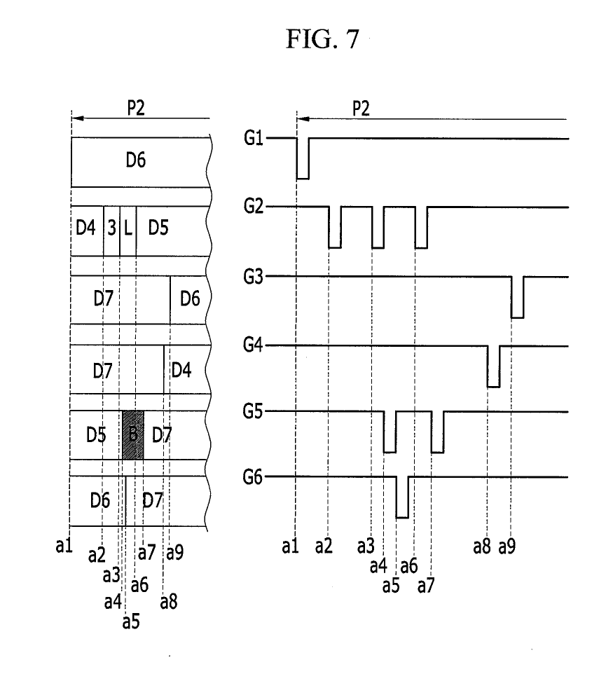

In FIG. 7, a scan signal timing of a portion of a driving waveform showing a driving method according to an exemplary embodiment of the present invention as shown in FIG. 6 will be described.

The sub-frames included in six scan lines are arranged in FIG. 6. FIG. 7 is an enlarged view of the sub-frame block corresponding to a period (e.g., a predetermined period) from a view point at which the second period P2 of the left-eye image display period is started. FIG. 7 shows the driving timing of the scan signal generated in synchronization with the view point of each corresponding sub-frame during the time (e.g., the predetermined time).

Referring to FIG. 7, the scan signal G1 transmitted to the first scan line among six scan lines generates a pulse of the gate-on voltage level in synchronization with the view point a1 at which the sub-frame D6 is started.

The gate-on voltage level of FIG. 7 is at a low level because the plurality of pixels of the display device according to an exemplary embodiment of the present invention shown in FIG. 2 are made of PMOS transistors. However, the gate-on voltage level may be differently set up according to the type of transistors of the pixel.

If the scan signal G1 is transmitted with the first scan line, the plurality of pixels coupled to the first scan line are activated according to the pulse of the gate-on voltage level. In one embodiment, a plurality of pixels coupled to the first scan line emit the light with the driving current corresponding to the transmitted left eye data signal during the sub-frame D6, thereby displaying the left-eye image.

Next, the time (e.g., the predetermined time) is passed such that the scan signal G2 supplied to the second scan line generates the pulse of a low level in synchronization with the view point a2.

If the scan signal G2 is transmitted to the second scan line, the plurality of pixels included in the second scan line are activated corresponding to the pulse of a low level. The plurality of pixels included in the second scan line receive the left eye data signal during the period of the corresponding sub-frame D3, thereby displaying the image according thereto.

Likewise, the scan signal G3 supplied to the third scan line, the scan signal G5 supplied to the fifth scan line, the scan signal G6 supplied to the sixth scan line, the scan signal G2 supplied to the second scan line, the scan signal G5 supplied to the fifth scan line, and the scan signal G4 supplied to the fourth scan line sequentially generate the pulse of a low level in synchronization with the view points a3, a4, a5, a6, a7, a8, and a9 according to the passage of time.

Accordingly, the plurality of pixels included in the corresponding scan line transmitted with the corresponding scan signal receive the left eye data signal during the corresponding sub-frame period and emit the light, thereby displaying the left-eye image.

The right-eye image is also displayed through the above-described method during the right-eye image display period.

According to the driving method of the stereoscopic image display device of embodiments of the present invention, the starting point of each sub-frame is not overlapped, thereby the view point at which the scan signal applied to each scan line generates the pulse of a low level is also not overlapped.

The driving method of the stereoscopic image display device according to an exemplary embodiment of the present invention in FIG. 6 and FIG. 7 blocks the crosstalk by not emitting light from the pixels of the display unit during the period corresponding to the response delay time of the shutter spectacles while being driven as a unit of a plurality of sub-frames. However, embodiments of the present invention may be applied to a progressive driving method in which the left eye image data signal or the right eye image data signal is sequentially written by sequentially transmitting a plurality of scan signals to a plurality of scan lines, as well as this driving method.

For example, at the opening and closing transition (e.g., converting) view point of the shutter spectacles, each light emission of a plurality of pixels of the display unit is blocked by controlling the switching (e.g., swing) or the on/off of the voltage level of the second driving voltage of the second power ELVSS during the period corresponding to the response delay time of the shutter spectacles. Thus, the pixels included in a plurality of pixel rows and selected by (e.g., transmitted with) the scan signal through a plurality of corresponding scan lines do not display the images during this period, however the loss of the luminance according thereto may be compensated by increasing the light emitting intensity of the image realized in the left-eye image display period or the right-eye image display period. That is, the driving current is increased by the lost luminance of the non-light emitting period by compensating the image data signal applied in the left-eye image display period or the right-eye image display period after the non-light emitting period, such that the light emitting intensity is increased, thereby displaying the normal left eye or right-eye images.

The drawings and detailed description described above are examples for the present invention and are provided to explain the present invention, but the scope of the present invention described in the claims is not limited thereto. Therefore, it will be appreciated by those skilled in the art that various modifications may be made and other equivalent embodiments are available. Further, a person having ordinary skill in the art may omit some of the constituent elements described in the specification without deteriorating performance or may add constituent elements in order to improve performance. In addition, a person having ordinary skill in the art may change the sequence of the steps described in the specification according to process environments or equipment. Accordingly, the scope of the present invention should be determined not by the above-described exemplary embodiments, but by the appended claims and equivalents thereof.

### DESCRIPTION OF SOME OF THE REFERENCE NUMERALS

| | |
|---|---|
| 10: display unit | 20: scan driver |
| 30: data driver | 40: pixel |
| 45: pixel circuit | 50: controller |
| 60: power supply controller | |

What is claimed is:

1. A stereoscopic image display device comprising:
a scan driver for transmitting a plurality of scan signals to a plurality of scan lines;
a data driver for transmitting a plurality of data signals to a plurality of data lines;
a display unit comprising a plurality of pixels and for displaying an image, the display unit being configured to receive a corresponding data signal when a corresponding scan signal is respectively transmitted to the plurality of pixels;
a power supply controller for supplying a driving voltage to drive the plurality of pixels; and
a controller for controlling the scan driver, the data driver, and the power supply controller, for generating an image data signal corresponding to each period of a plurality of periods, wherein the periods are formed by dividing one frame into a first view point image non-light emitting period, a first view point image display period, a second view point image non-light emitting period, and a second view point image display period, and for supplying the corresponding image data signal to the data driver,
wherein the power supply controller controls the supply of the driving voltage to block light emitting of the plurality of pixels during the first view point image non-light emitting period and the second view point image non-light emitting period.

2. The stereoscopic image display device of claim 1, wherein
the driving voltage comprises a first driving voltage applied to one electrode of each organic light emitting element of the plurality of pixels and a second driving voltage applied to another electrode of each organic light emitting element.

3. The stereoscopic image display device of claim 2, wherein
the power supply controller supplies a voltage of the second driving voltage during the first view point image non-light emitting period and the second view point image non-light emitting period at a voltage level at which a driving current does not flow to the organic light emitting element to block the light emitting of a plurality of pixels.

4. The stereoscopic image display device of claim 2, wherein
the power supply controller does not apply the second driving voltage during the first view point image non-light emitting period and the second view point image non-light emitting period to block the light emitting of the plurality of pixels.

5. The stereoscopic image display device of claim 2, wherein
the power supply controller supplies the first driving voltage at a high level, and supplies the second driving voltage at a high level during the first view point image non-light emitting period and the second view point image non-light emitting period and at a low level during the first view point image display period and the second view point image display period.

6. The stereoscopic image display device of claim 2, wherein
the power supply controller supplies the first driving voltage at a high level, and does not supply the second driving voltage during the first view point image non-light emitting period and the second view point image non-light emitting period, and supplies the second driving voltage at a low level during the first view point image display period and the second view point image display period.

7. The stereoscopic image display device of claim 1, wherein
the first view point image non-light emitting period and the second view point image non-light emitting period are substantially equal to or longer than a response delay time of a shutter opening and closing of shutter spectacles for transmitting a first view point image and a second view point image of the image of the display unit.

8. The stereoscopic image display device of claim 1, wherein
the first view point image non-light emitting period and the first view point image display period form a left eye frame, the second view point image non-light emitting period and the second view point image display period form a right eye frame, and
the periods of the left eye frame and the right eye frame are substantially equal to each other.

9. The stereoscopic image display device of claim 8, wherein
the data voltage according to the image data signal written in a previous frame is respectively reset at a start time of the left eye frame and a start time of the right eye frame.

10. The stereoscopic image display device of claim 1, wherein
the image data signal supplied in the first view point image non-light emitting period and the first view point image display period is a left eye image data signal and the image data signal supplied in the second view point image non-light emitting period and the second view point image display period is a right eye image data signal.

11. The stereoscopic image display device of claim 1, wherein
the first view point image non-light emitting period and the first view point image display period comprise a plurality of first sub-frames, and the second view point image non-light emitting period and the second view point image display period comprise a plurality of second sub-frames.

12. The stereoscopic image display device of claim 11, wherein
the plurality of first sub-frames comprises a plurality of third sub-frames which form the first view point image non-light emitting period, and a plurality of fourth sub-frames which form the first view point image display period, and
the plurality of second sub-frames comprises a plurality of fifth sub-frames which form the second view point image non-light emitting period, and a plurality of sixth sub-frames which form the second view point image display period.

13. The stereoscopic image display device of claim 11, wherein
the plurality of first sub-frames and the plurality of second sub-frames are substantially equally arranged, and
the plurality of first sub-frames and the plurality of second sub-frames respectively comprise a blank sub-frame for adjusting discord of synchronization generated when the first and second sub-frames are arranged in one frame period.

14. The stereoscopic image display device of claim 1, wherein
the first view point image non-light emitting period and the first view point image display period comprise a plurality of first sub-frames,
the scan driver transmits the scan signal respectively corresponding to the plurality of first sub-frames to the corresponding scan line, and
the data driver supplies a plurality of first view point data signals to the plurality of data lines at a time at which the corresponding scan signal is transmitted to the corresponding scan line.

15. The stereoscopic image display device of claim 1, wherein
the second view point image non-light emitting period and the second view point image display period comprise a plurality of second sub-frames,
the scan driver transmits the scan signal respectively corresponding to the plurality of second sub-frames to the corresponding scan line, and
the data driver supplies a plurality of second view point data signals to the plurality of data lines at a time at which the corresponding scan signal is transmitted to the corresponding scan line.

16. The stereoscopic image display device of claim 1, wherein
the first view point image non-light emitting period and the first view point image display period comprise a plurality of first sub-frames, the second view point image non-light emitting period and the second view point image display period comprise a plurality of second sub-frames, and
a sequence in which a plurality of corresponding scan signals are respectively transmitted to the plurality of first sub-frames is substantially the same as a sequence in which a plurality of corresponding scan signals are respectively transmitted to the plurality of second sub-frames.

17. The stereoscopic image display device of claim 1, wherein
a scan sequence in which the scan signals respectively corresponding to a plurality of sub-frames forming the first view point image non-light emitting period are transmitted, and a scan sequence in which the scan signals respectively corresponding to a plurality of sub-frames forming the second view point image non-light emitting period are transmitted, are substantially the same, and
a sequence in which the scan signals respectively corresponding to a plurality of sub-frames from a period before respective finishing times of the first view point image display period and the second view point image display period to the respective non-light emitting period, are transmitted, is substantially the same as the scan sequence.

18. The stereoscopic image display device of claim 1, wherein
the scan driver sequentially transmits the plurality of scan signals in synchronization with a start time of the first view point image non-light emitting period and a start time of the second view point image non-light emitting period, and
the controller generates a first view point image data signal or a second view point image data signal respectively corresponding to the first view point image display period or the second view point image display period, and compensates the first view point image data signal or the second view point image data signal by an image luminance loss corresponding to the first view point image non-light emitting period or the second view point image non-light emitting period.

19. A method of driving a stereoscopic image display device comprising a plurality of pixels and configured to display a first view point image and a second view point image during one frame period, the method comprising:
generating and supplying a first view point image data signal corresponding to a first view point image non-light emitting period and a first view point image display period and a second view point image data signal corresponding to a second view point image non-light emitting period and a second view point image display period;
controlling a driving voltage respectively supplied to the plurality of pixels during the first view point image non-light emitting period for blocking light-emitting of the plurality of pixels;
emitting light from the plurality of pixels according to the first view point image data signal during the first view point image display period;
controlling the driving voltage during the second view point image non-light emitting period to block light-emitting of the plurality of pixels; and
emitting light from the plurality of pixels according to the second view point image data signal during the second view point image display period,
wherein the first view point image non-light emitting period and the second view point image non-light emitting period are substantially equal to or longer than a response delay time of a shutter opening and closing of shutter spectacles for transmitting the first view point image and the second view point image displayed in the plurality of pixels.

20. The method of claim 19, wherein
the driving voltage comprises a first driving voltage applied to one electrode of each organic light emitting element of the plurality of pixels and a second driving voltage applied to another electrode of each organic light emitting element.

21. The method of claim 20, wherein
a voltage level of the second driving voltage is supplied with a voltage level at which a driving current does not flow to the organic light emitting element during the first view point image non-light emitting period and the second view point image non-light emitting period to block the light-emitting of the plurality of pixels.

22. The method of claim 20, wherein
the second driving voltage is not applied during the first view point image non-light emitting period and the second view point image non-light emitting period to block the light-emitting of the plurality of pixels.

23. The method of claim 20, wherein
the first driving voltage is supplied with a high level, and the second driving voltage is supplied as a high level during the first view point image non-light emitting period and the second view point image non-light emitting period and as a low level during the first view point image display period and the second view point image display period.

24. The method of claim 20, wherein
the first driving voltage is supplied with a high level, and the second driving voltage is not supplied during the first view point image non-light emitting period and the second view point image non-light emitting period, and is supplied with a low level during the first view point image display period and the second view point image display period.

25. The method of claim 19, wherein
the first view point image non-light emitting period and the first view point image display period form a left eye frame, the second view point image non-light emitting period and the second view point image display period form a right eye frame, and
the periods of the left eye frame and the right eye frame are substantially equal to each other.

26. The method of claim 19, further comprising
resetting a data voltage according to an image data signal written in a previous frame at a start time of the first view point image non-light emitting period and a start time of the second view point image non-light emitting period.

27. The method of claim 19, wherein
the first view point image non-light emitting period and the first view point image display period comprise a plurality of first sub-frames, and the second view point image non-light emitting period and the second view point image display period comprise a plurality of second sub-frames.

28. The method of claim 27, wherein
the plurality of first sub-frames and the plurality of second sub-frames are substantially equally arranged, and
the plurality of first sub-frames and the plurality of second sub-frames further comprise a blank sub-frame for controlling disaccord of synchronization generated when the first and second sub-frames are arranged in one frame period.

29. The method of claim 27, wherein
the plurality of first sub-frames included in the first view point image non-light emitting period and the second view point non-light emitting period are repeated during a period corresponding to the first view point image non-light emitting period and the second view point non-light emitting period from a time before respective finishing times of the plurality of first sub-frames and the plurality of second sub-frames.

30. The method of claim 19, wherein
the generating and supplying of the first view point image data signal and the second view point image data signal comprises compensating an image luminance loss corresponding to the first view point image non-light emitting period or the second view point image non-light emitting period.
